(19) United States
(12) Patent Application Publication
(10) Pub. No.: US 2015/0294388 A1
(43) Pub. Date: Oct. 15, 2015

(54) METHOD AND SYSTEM OF CATEGORY PATH RECOGNITION

(71) Applicant: BEIJING JINGDONG SHANGKE INFORMATION TECHNOLOGY CO., LTD., Beijing (CN)

(72) Inventors: Defeng HU, Shenzhen City (CN); Zhengping Zhu, Shenzhen City (CN); Chao Ma, Shenzhen City (CN)

(21) Appl. No.: 14/748,618

(22) Filed: Jun. 24, 2015

Related U.S. Application Data
(63) Continuation of application No. PCT/CN2013/088002, filed on Nov. 28, 2013.

(30) Foreign Application Priority Data
Dec. 25, 2012 (CN) 201210572005.2

(51) Int. Cl. G06Q 30/06; G06F 17/30

(52) U.S. Cl. CPC G06Q 30/0625; G06F 17/30873; G06F 17/30867

(57) ABSTRACT

A method and server for processing item identifiers, and a computer readable storage medium are disclosed. In one aspect, the method includes obtaining from a user device over a network, by a server, a commodity title input by the user through the user device and performing, by the server, word segmentation on the commodity title to obtain a keyword set comprising keywords comprised in the commodity title. The method also includes determining, by the server, a category path of the commodity title according to the keyword set and a preconfigured commodity category recognition model. The commodity category recognition model comprises correspondences between a plurality of keywords and a plurality of category paths and a counting value of the number of occurrences of each of the keywords under each corresponding category path.

### CROSS REFERENCE TO RELATED APPLICATIONS

This application is a continuation of International Application No. PCT/CN2013/088002, filed Nov. 28, 2013, which claims the benefit under 35 U.S.C. §119 of Chinese Patent Application No. 201210572005.2, filed on Dec. 25, 2012, which are hereby incorporated by reference in their entirety.

### BACKGROUND

With the development of e-commerce, it has become popular for Internet users to open online shops and shop online. An online transaction system provides an online trading platform, where all commodities in a website will be classified under a classification path, which would be convenient for users to find a desired commodity, and this classification can be referred to as a category. For example, the category path for a commodity such as “Metersbonwe sport pants” is “sportswear/bags/accessories>sportswear>sport pants”, where the “sportswear/bags/accessories” is a first-level category, the “sportswear” is a second-level category, and the “sport pants” is a third-level category. An online trading platform can manage the commodity in the online shop in accordance with their categories.

In a website of Consumer to Consumer (C2C for short) or a website of Business-to-Customer (B2C for short), when issuing a commodity, a seller or operational person not only needs to fill in the name of the commodity but also needs to manually select the first-level category, the second-level category, . . . , and the lowest-level category of the commodity. However, there are several options even in each level of category, and sometimes, a situation where multiple categories are relatively suitable for the commodity but not particularly suitable can occur, so the seller operational person has to look through carefully and may feel difficult to make a decision on the category selection. In such situations, a wrong category may have a higher likelihood of being selected for the commodity.

### SUMMARY OF CERTAIN INVENTIVE ASPECTS

One inventive aspect is method of category path recognition, in which a server obtains from a user device over a network a commodity title a user inputs through the user device, the server performs word segmentation on the commodity title to obtain a keyword set including keywords included in the commodity title, and determines a category path of the commodity title according to the keyword set and a preconfigured commodity category recognition model, where the commodity category recognition model includes correspondences between a plurality of keywords and a plurality of category paths and a counting value of the number of occurrences of each of the plurality of keywords under each corresponding category path.

Another aspect is a system of category path recognition, in which the system includes a memory and a processor, wherein the memory stores instruction units executable for the processor, and the instruction units include an obtaining unit, a processing unit and a determination unit, where, the obtaining unit is to obtain from a user device over a network a commodity title a user inputs through the user device, the processing unit is to perform word segmentation on the commodity title to obtain a keyword set comprising keywords comprised in the commodity title, and the determination unit is to determine a category path of the commodity title according to the keyword set and a preconfigured commodity category recognition model, where the commodity category recognition model comprises correspondences between a plurality of keywords and a plurality of category paths and a counting value of the number of occurrences of each of the plurality of keywords under each corresponding category path.

Accordingly, a machine-readable storage medium storing instructions to cause a machine to execute the above method is disclosed.

### BRIEF DESCRIPTION OF THE DRAWINGS

FIG. 1 illustrates a flow chart of a method for recognizing a category path in an example of the present disclosure.

FIG. 2 illustrates a flow chart of a method for recognizing a category path in another example of the present disclosure.

FIG. 3 illustrates a structure diagram of a system for recognizing a category path in an example of the present disclosure.

FIG. 4 illustrates a structure diagram of a system for recognizing a category path in another example of the present disclosure.

FIG. 5 illustrates a structure diagram of a second calculation unit of the system in an example of the present disclosure.

### DETAILED DESCRIPTION OF CERTAIN INVENTIVE EMBODIMENTS

Examples will now be described more fully with reference to the accompanying drawings.

The following description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical operation (A or B or C), using a non-exclusive logical OR. It should be understood that one or more steps within a method may be executed in different order (or concurrently) without altering the principles of the present disclosure.

As used herein, the term “module” or “unit” or “sub-unit” or “sub-module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term “module” or “unit” or “subunit” or “sub-module” may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

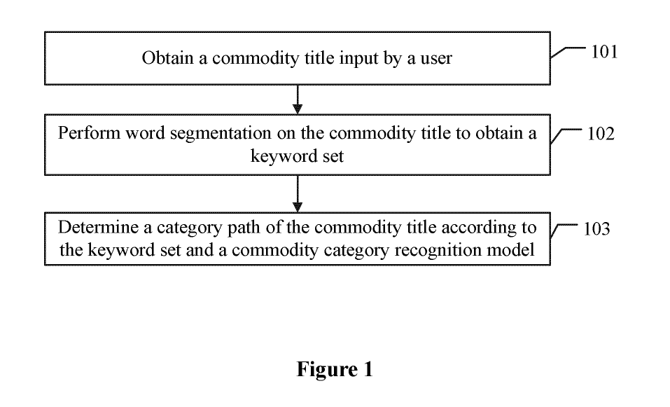

The description will be made as to the various embodiments in conjunction with the accompanying drawings in FIGS. 1-5. It should be understood that specific embodiments described herein are merely intended to explain the present disclosure, but not intended to limit the present disclosure. In accordance with the purposes of this disclosure, as embodied and broadly described herein, this disclosure, in one aspect, relates to method and apparatus for managing an identity for a mobile terminal.

Examples of user devices that can be used in accordance with various embodiments include, but are not limited to, a Personal Computer (PC), a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to one skilled in the art.

Examples of the present disclosure provide a method and system for recognizing a category path, in which when an user issues information of a commodity, a category path of a commodity title inputted by the user is automatically recognized, and the user does not need to determine the category path of the commodity title level by level. Therefore, the category path recognition of the commodity title can be accomplished efficiently, and operating efficiencies and accuracy of the category recognition can be improved.

In an example of the present disclosure, a pre-configured commodity category recognition model is used to determine the category path of the commodity title inputted by the user. In an example, a model establishment system acquires data of correspondence between all commodity titles and their respective category paths from a database of a C2C website or a B2C website, and the model establishment system divides the acquired data into a first data and a second data randomly or according to a predefined ratio which may be, for example, 5:5 or 7:3 or etc.

In an example of the present disclosure, after dividing the data of correspondence between the commodity titles and the category paths saved in the system into the first data and the second data, the model establishment system utilizes the first data to establish a commodity category recognition model, and to utilize the second data to optimize and verify the established commodity category recognition model so as to determine the category path of the commodity title with a higher accuracy by using the commodity category recognition model.

In an example, the commodity category recognition model is established utilizing the first data by the following process:

1) Perform or calculate statistics on the correspondence between the commodity titles and their category paths in the first data, determine the number of occurrences of commodity titles under the same category path for each category path, and generate a category path count table which includes a total counting value of the commodity titles under each category path in the first data.

For example, there are 57 commodity titles in total under the category path of “women's apparel/ladies boutiques>pants>ladies jeans”, and there are 107 commodity titles in total under the category path of “sportswear/bags/accessories>sportswear>sports pants”.

2) Perform word segmentation on all commodity titles in the first data, obtain all keywords of all the commodity titles, calculate the number of occurrences for each keyword and take the number of occurrences as the counting value of the keyword, and generate a keyword count table which includes the total counting value of each keyword in the first data.

For example, if the first commodity title is “HSTYLE Korean fashion women's apparel slim worn-out straight-leg jeans” and the second commodity title is “Metersbonwe fashion women's apparel slim straight-leg jeans”, the keywords obtained through performing word segmentation on the first commodity title include “HSTYLE”, “Korean”, “fashion”, “women's apparel”, “slim”, “worn-out”, “straight-leg” and “jeans”, and the keywords obtained through performing word segmentation on the second commodity title include “Metersbonwe”, “fashion”, “women's apparel”, “slim”, “straight-leg” and “jeans”, thereby the total counting value of occurrences of each keyword can be obtained through performing or calculating statistics on the keywords in the first commodity title and the second commodity title, i.e., the counting value of “HSTYLE” is 1, that of “Korean” is 1, that of “fashion” is 2, that of “women's apparel” is 2, that of “slim” is 2, that of “worn-out” is 1, that of “straight-leg” is 2, that of “jeans” is 2 and that of “Metersbonwe” is 1.

3) Process the one-to-one correspondence between the commodity titles and their category paths in the first data to establish a one-to-more correspondence between the category paths and the commodity titles.

For example, the one-to-one correspondence between the commodity titles and their category paths in the first data are as shown in a table below:

TABLE 1

| Commodity Title | Category Path |
|---|---|
| Metersbonwe fashion women's | women's apparel/ladies boutiques > |
| apparel slim straight-leg jeans | pants > ladies jeans |
| Before the Law | books > law > popular law books |
| Jay Chou Ten CDs of Jay | Music > Chinese Pop Music > |
| Chou (10 CD) | male singers |
| Korean fashion women's | women's apparel/ladies boutiques > |
| apparel slim worn-out | pants > ladies jeans |
| straight-leg jeans | |
| 1000 Common Knowledge in | books > law > popular law books |
| Law that You Must Know | Music > Chinese Pop Music > |
| Jacky Chueng All Jacky | male singers |
| Chueng (4 CD) | |
| Ochirly women's apparel slim | women's apparel/ladies boutiques > |
| skinny jeans | pants > ladies jeans |
| Overcoming Law | books > law > popular law books |
| Jay Chou Common Jasmine | Music > Chinese Pop Music > |
| Orange | male singers |

The one-to-more correspondence between the category paths and the commodity titles may be obtained after processing the data in the above Table 1, and the details of the one-to-more correspondence can be seen in a table below:

TABLE 2

| Commodity Title | Category Path |
|---|---|
| Metersbonwe fashion women's | women's apparel/ladies boutiques > |
| apparel slim straight-leg jeans | pants > ladies jeans |
| HSTYLE Korean fashion | |
| women's apparel slim worn- | |
| out straight-leg jeans | |
| Ochirly women's apparel | |
| slim skinny jeans | |
| Before the Law | books > law > popular law books |
| 1000 Common Knowledge in | |
| Law that You Must Know | |
| Overcoming Law | |
| Jay Chou Ten CDs of Jay Chou | Music > Chinese Pop Music > |
| (10 CD) | male singers |
| Jacky Chueng All Jacky | |
| Chueng (4 CD) | |
| Jay Chou Common Jasmine | |
| Orange (CD) | |

In an example of the present disclosure, after obtaining the one-to-more correspondence between the category paths and the commodity titles, the model establishment system performs or calculates statistics on the commodity titles under each category path, specifically including steps of: for each category path, performing word segmentation on all the commodity titles under the category path to obtain all the keywords under the category path and performing or calculating statistics on all the obtained keywords to determine the number of occurrences of each keyword under the category path; and generating a keyword and category path count table which includes the correspondence between a category path and the keywords for each of the one-to-more correspondences between the category paths and their commodity titles, as well as the counting value of occurrences of the keywords under each corresponding category path.

In an example of the present disclosure, the model establishment system utilizes the first data to obtain a category path count table, a keyword count table and a keyword and category path count table, and takes these tables together with calculation formulas for an initial integrated counting value of the commodity title under the category path as an initial commodity category recognition model, where the calculation formulas for the initial integrated counting value of the commodity title under the category path are as follows:

S(P, Kᵢ)=T/(A*Kᵢ+B*P) Formula (1)

S(P, K)=S(P, K₁)*S(P, K₂)* . . . . *S(P, Kₙ) Formula (2)

In the above formulas, P represents a total counting value of the commodity titles under the category path Y corresponding to the commodity title X in the category path count table, Ki is the i^{th} keyword in the keywords set K of the commodity title X, T represents a counting value of the number of occurrences of the keyword Kᵢ under the category path Y in the keyword and category path count table, S(P, Kᵢ) represents a counting value of the number of occurrences of the keyword Kᵢ under the category path P, S(P, K) represents an integrated counting value of the keyword set K of the commodity title X under the category path Y, n represents the number of the keywords in the keyword set K of the commodity title X, and A and B are predefined constant values.

In order to improve the accuracy of the initial commodity category recognition model, the second data may be utilized to calculate the accuracy of this initial commodity category recognition model, so that the values of the parameters A and B can be corrected according to the calculated accuracy, and then the corrected parameters A and B are substituted into Formula (1) to obtain a corrected Formula (1), thereby a corrected initial commodity category recognition model is obtained. And the second data is further used to calculate the accuracy of the corrected initial commodity category recognition model. Such process can be repeated, so that the initial commodity category recognition model can be corrected several times until the accuracy of the corrected initial commodity category recognition model meets a value predefined by the model establishment system. And the corrected initial commodity category recognition model finally obtained is taken as a final commodity category recognition model.

In an example of the present disclosure, the method for utilizing the second data to calculate the recognition accuracy of the initial commodity category model includes the following process:

The one-to-one correspondence between each commodity title and its category path in the second data is processed according to the following example for the commodity title X and its corresponding category path Z:

Word segmentation is performed on the commodity title X to obtain the keyword set K of the commodity title X. A category path set including all the category paths containing the keyword K is obtained by searching the keyword and category path count table. Then, the integrated counting value of the commodity title X under each category path in this category path set is calculated respectively. For example, when calculating the integrated counting value of the commodity title X under the category path Y in the category path set, the counting value of the number of occurrences of each keyword in the keyword set K of the commodity title X is calculated according to Formula (1), and the integrated counting value of the commodity title X under the category path Y is calculated according to Formula (2).

After obtaining the integrated counting value of the commodity title X for each category path in the category path set according to Formulas (1) and (2), the category path corresponding to the largest integrated counting value is selected to compare with the category path Z that corresponds to the commodity title X in the second data. If the category path corresponding to the largest counting value is exactly the same with the category path Z, it indicates that category path recognition for this commodity title X is correct, and otherwise, if the category path corresponding to the largest integrated counting value is not exactly the same with the category path Z, it indicates that the category path recognition for this commodity title X is incorrect.

In an example of the present disclosure, after the one-to-one correspondence between each commodity title and its category path in the second data is processed, the model establishment system statistically calculates the number of correct category path recognitions and the number of incorrect category path recognitions for the commodity title in the second data to obtain the accuracy of category recognition which is taken as the accuracy of the initial commodity category model. And then, the model establishment system further compares this accuracy and a predefined value, if this accuracy is no less than the predefined value, the parameters A and B do not need correction; and otherwise, if this accuracy is less than the predefined value, the parameters A and B are corrected so as to correct the initial commodity category recognition model. And then, the accuracy of the corrected initial commodity category model is calculated utilizing the second data according to the above method, and this accuracy is used to determine whether the current parameters A and B need further correction. If the current parameters A and B need correction, the above process will be repeated. If the current parameters A and B do not need correction, the current commodity category recognition model is taken as the final one which does not need further correction.

In an example of the present disclosure, the values of the parameters A and B may be corrected according to a user's input or a correction method preconfigured. In practice, the parameters A and B may be corrected by various methods according to specific requirements.

In an example of the present disclosure, the model establishment system may configure the established commodity category recognition model in a category path recognition system which will utilize this commodity category recognition model to determine a category path of a commodity title input by a user. Either of the model establishment system and the category path recognition system may be loaded in a server at the network side. Referring to FIG. 1, a category path recognition method in an example of the present disclosure includes the following blocks:

In Block 101, a commodity title input by a user is obtained by the category path recognition system.

In the example, the user may utilize the category path recognition system to realize an automatic recognition to the category path of the commodity title, after the user inputs a commodity title through an user device, the commodity title input by the user can be obtained from the user device by the category path recognition system in a server over a network.

In Block 102, word segmentation is performed on the commodity title, and a keyword set of the commodity title is obtained.

In an example of the present disclosure, the category path recognition system performs word segmentation on the commodity tile to obtain the keyword set thereof. For example, if the commodity title is “HSTYLE Korean fashion women's apparel slim worn-out straight-leg jeans”, the keyword set obtained includes keywords of “HSTYLE”, “Korean”, “fashion”, “women's apparel”, “slim”, “worn-out”, “straight-leg” and “jeans”, and if the commodity title is “Metersbonwe Fashion women's apparel slim straight-leg jeans”, the keyword set obtained includes keywords of “Metersbonwe”, “Fashion”, “women's apparel”, “slim”, “straight-leg” and “jeans”.

In Block 103, a category path of the commodity title is determined by the category path recognition system according to the keyword set obtained in Block 102 and a preconfigured commodity category recognition model. Then the category path determined by the category path recognition system may be returned to the user device by the server loading the category path recognition system, so that the user device can automatically present the category path to facilitate the user's operations.

In the example of the present disclosure, the category path recognition system performs word segmentation on the commodity title input by the user to obtain the keyword set of the commodity title, and then utilizes the keyword set and the preconfigured commodity category recognition model to determine the category path of the commodity title, so that the category path recognition of the commodity title can be realized automatically without the user's determining the category path level by level, and thus incorrect category path determination due to the user's wrong operations can be avoided, and operating efficiency and accuracy of the category recognition can be improved thereby.

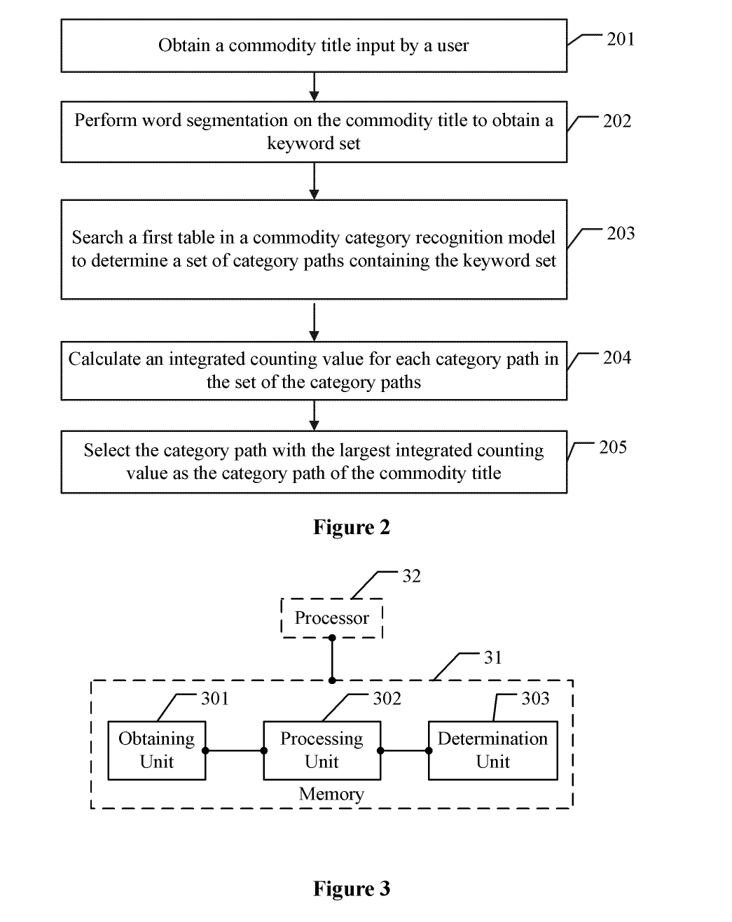

FIG. 2 shows a method of category path recognition in an example of the present disclosure which includes the following blocks:

In Block 201, a commodity title input by a user is obtained, and in Block 202, word segmentation is performed on the commodity title, and a keyword set of the commodity title is obtained. The Blocks 201 and 202 are similar to the Blocks 101 and 102 and will not be described in detail herein.

In Block 203, a set of category path including the keyword set is determined by searching the keyword set in a keyword and category path count table of a commodity category recognition model, where the keyword and category path count table includes the correspondences between category paths and keywords as well as a counting value of the number of occurrences of each keyword under its corresponding category path.

In an example, the category path recognition system includes a commodity category recognition model which includes a keyword and category path count table, a keyword count table and a category path count table. The keyword and category path count table includes the correspondences between category paths and keywords as well as the counting value of the number of occurrences of each keyword under its corresponding category path. The keyword count table contains the counting value of the total number of occurrences of each keyword, and the category path count table contains the total counting value of the number of the commodity titles under each category path.

In Block 204, the integrated counting value of each category path in the set of category paths is calculated respectively by the category path recognition system.

In an example, the integrated counting value of one category path of the set of category paths is calculated through the following steps:

In Step A, a keyword counting value of each keyword of the keyword set under the category path is calculated respectively.

Here, the keyword counting value of one keyword of the keyword set is calculated through the following Steps A1 and A2:

In Step A1, a first counting value of the number of occurrences of the keyword under the category path is determined by searching the keyword and category path count table, a second counting value of the number of occurrences of the keyword is determined by searching the keyword count table, and a third counting value of the total number of the commodity titles under the category path is determined by searching the category path count table.

In Step A2, the keyword counting value of the keyword under the category path is calculated according to the first counting value, the second counting value and the third counting value.

Here, the category recognition system uses Formula (1) of the commodity category recognition model to determine the keyword counting value of the keyword under the category path, including: making the sum of the product of the second counting value and a predefined first parameter and the product of the third counting value and a predefined second parameter as a fourth counting value, making the quotient of the first counting value divided by the fourth counting value as the keyword counting value of the keyword under the category path, where Formula (1) is as follows:

S(P, Kᵢ)=T/(A*Kᵢ+B*P) (1)

Here, the third counting value is P, P represents the total counting value of the commodity titles under the category path Y corresponding to the commodity title X in the category path count table, the second counting value is Kᵢ is the i^{th} keyword in the keyword set K of the commodity title X, the first counting value is T, T represents the counting value of the number of occurrences of the keyword Kᵢ under the category path Y in the keyword and category path count table, and the sum of A* Kᵢ and B*P is the fourth counting value, S (P, Kᵢ) represents the keyword counting value of the keyword Kᵢ under the category path P, A represents a parameter A which is the first predefined parameter, B represents a parameter B which is the second predefined parameter, where the values of the parameters A and B may have been corrected which can make the accuracy of the commodity category recognition model no less than a predefined parameter value.

In Step B, the product of the keyword counting values of the keywords of the keyword set is calculated, and the product is regarded as the integrated counting value of the category path.

In an example, the product of the keyword counting values of the keywords of the keyword set is calculated by Formula (2) below:

S(P, K)=S(P, K₁)*S(P, K₂)* . . . * S(P, Kₙ) (2)

Here, S(P, Kᵢ) represents the keyword counting value of the keyword Kᵢ under the category path P, S(P, K) represents the integrated counting value of the keyword set K of the commodity title X under the category path Y.

In Block 205, the category path with the largest integrated counting value in the set of category paths is selected as the category path of the commodity title.

In the example of the present disclosure, the category path recognition system selects the category path with the largest integrated counting value among the set of category paths corresponding to the keyword set of the commodity title input by the user, and takes the selected category path as the category path of the commodity title input by the user, so that automatic recognition of the category path for the commodity title input by the user can be realized.

In the example of the present disclosure, after obtaining the keyword set of the commodity title input by the user and determining the set of category paths containing the keyword set, the category path recognition system can further calculate the integrated counting value of each category path in the set of category paths to select the category path with the largest integrated counting value as the category path of the commodity title input by the user, so that effective recognition of the category path of the commodity title can be realized without the user's determining the category path for the commodity title level by level, thereby reducing the user's workload and saving the user's time, and further the incorrect category path recognition due to the user's wrong operations can be avoided, thereby effectively improving user experiences and processing efficiency of the user's device.

For a better understanding of the method of category path recognition in the example of the present disclosure, a specific application scenario will be described below.

The commodity title input by the user is “Metersbonwe, fashion women's apparel slim straight-leg jeans”. The category path recognition system obtains the commodity title of “Metersbonwe fashion women's apparel slim straight-leg jeans”, and performs word segmentation on this commodity title and obtains the keyword set which specifically includes keywords of: “Metersbonwe”, “fashion”, “women's apparel”, “slim”, “straight-leg” and “jeans”. Then, the category path recognition system utilizes the keyword and category path count table in the preconfigured commodity category recognition model to obtain the set of category paths containing the keyword set {“Metersbonwe”, “fashion”, “women's apparel”, “slim”, “straight-leg”, “jeans”}, and the obtained set of the category paths includes category paths of: “women's apparel/ladies boutique>pants>ladies jeans” and “books>clothing>women's clothing matching>jeans matching”.

The category path recognition system processes the two category paths in the obtained set of the category paths respectively. Specifically, the category path recognition system searches the keyword and category path count table in the commodity category recognition model to determine a first counting value of the number of occurrences of each keyword in the keyword set {“Metersbonwe”, “fashion”, “women's apparel”, “slim”, “straight-leg”, “jeans”} under the category path “women's apparel/ladies boutique>pants>ladies jeans”. The first counting values for those keywords are 100, 200, 50, 80, 300 and 400 respectively. The category path recognition system continues to determine a second counting value of the number of occurrences of each keyword in the keyword set {“Metersbonwe”, “fashion”, “women's apparel”, “slim”, “straight-leg”, “jeans”} by searching the keyword count table in the commodity category recognition model, and the second counting values of those keywords are 300, 500, 1000, 400, 200 and 700 respectively. The category path recognition system continues to look up the total number of the commodity titles under the category path “women's apparel/ladies boutique>pants>ladies Jeans” by searching the category path count table in the commodity category recognition model, and the total number is 1000. Consequently, the category path recognition system utilizes the obtained counting values to calculate the keyword counting value of each keyword in the keyword set {“Metersbonwe”, “fashion”, “women's apparel”, “slim”, “straight-leg”, “jeans”} in accordance with Formula (1) assuming that the parameters A and B are both 0.01 therein, and the keyword counting values are respectively 7.69, 13.33, 2.5, 5.71, 25 and 23.5. The category path recognition system multiplies those keyword counting values to obtain the integrated counting value of the category path for the commodity title of “Metersbonwe fashion women's apparel slim straight-leg jeans” under the category path “women's apparel/ladies boutique>pants>ladies jeans”, and this integrated counting value is 344305.27. According to the same method, the category path recognition system obtains the integrated counting value of the category path for the commodity title of “Metersbonwe fashion women's apparel slim straight-leg jeans” under the category path of “books>clothing>women's clothing matching>jeans matching” which is 756. Then, the category path “women's apparel/ladies boutique>pants>ladies jeans” with the largest integrated counting value is selected as the category path of the commodity title of “Metersbonwe fashion women's apparel slim straight-leg jeans”. Thus, automatic recognition of the category path of the commodity title can be realized without the user's determining the category path for the commodity title level by level, thereby reducing the user's workload and saving the user's time, and further the incorrect category path recognition due to the user's wrong operations can be avoided, thereby effectively improving processing efficiency and accuracy of the category recognition.

FIG. 3 shows a structure of a system of category path recognition in an example of the present disclosure. The system includes an obtaining unit 301, a processing unit 302 and a determination unit 303.

The obtaining unit 301 is adapted to obtain a commodity title input by a user. The processing unit 302 is adapted to perform word segmentation on the commodity title to obtain a keyword set comprising keywords contained in the commodity title obtained by the obtaining unit 301. The determination unit 303 is adapted to determine the category path of the commodity title according to the keyword set obtained by the processing unit 302 and a preconfigured commodity category recognition model. Here, the commodity category recognition model has been described in the examples of the method and will not be described in detail herein.

In the example of the present disclosure, the category path recognition system performs word segmentation on the commodity title input by the user to obtain the keyword set of the commodity title, and then utilizes the keyword set and the preconfigured commodity category recognition model to determine the category path of the commodity title, so that the category path recognition of the commodity title can be realized automatically without the user's determining the category path level by level, and thus incorrect category path determination due to the user's wrong operations can be avoided, and operating efficiency and accuracy of the category recognition can be improved thereby.

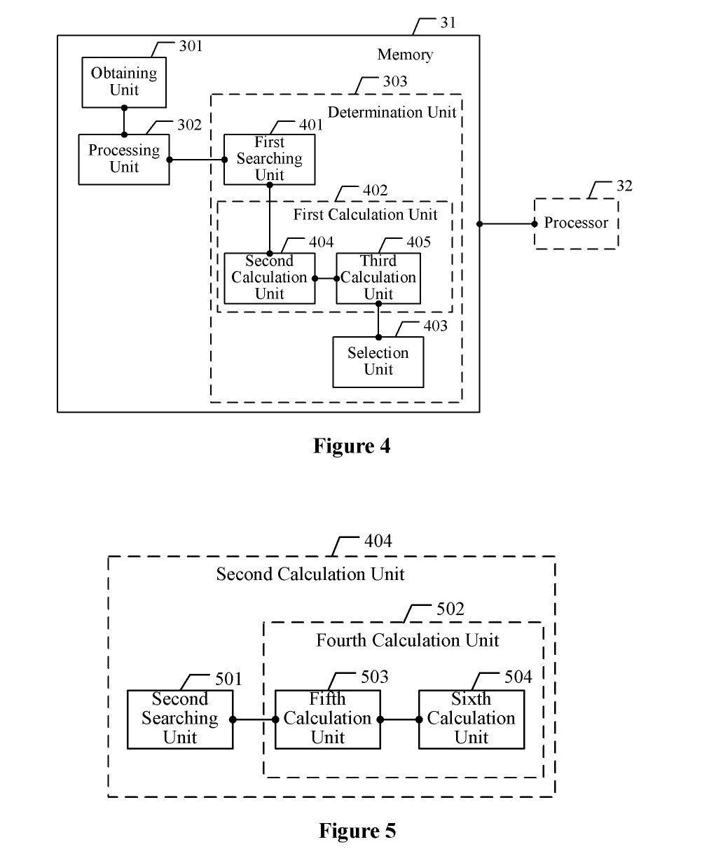

FIG. 4 shows a structure of a system of category path recognition in another example of the present disclosure. The system includes an obtaining unit 301, a processing unit 302 and a determination unit 303, where the obtaining unit 301 and the processing unit 302 are identical with those shown in FIG. 3 and will not be described in detail herein.

As shown in FIG. 4, the determination unit 303 includes a first searching unit 401, a first calculation unit 402 and a selection unit 403.

The first searching unit 401 is adapted to search the keyword and category path count table in the commodity category recognition model to obtain a set of category paths containing the keyword set after the processing unit 302 obtains the keyword set, where the keyword and category path count table contains the correspondences between the category paths and the keywords as well as the counting value of the number of occurrences of each of the keywords under each corresponding category path.

The first calculation unit 402 (namely a calculation unit) is adapted to respectively calculate the integrated counting value of each category path in the set of the category paths obtained by the first searching unit 401.

The selection unit 403 is adapted to select the category path with the largest integrated counting value in set of the category paths as the category path of the commodity title after the first calculation unit 402 obtains the integrated counting value of each category path in the set of the category paths.

In an example, the first calculation unit 402 includes a second calculation unit 404 (namely a first calculation subunit) and a third calculation unit 405 (namely a second calculation subunit), and the second calculation unit 404 and the third calculation unit 405 respectively calculate the integrated counting value of each category path in the set of the category paths. Specifically, for each category path in the set of the category paths, the second calculation unit 404 calculates the keyword counting value of each keyword in the keyword set under the category path, and the third calculation unit 405 calculates the product of the keyword counting values of the keywords in the obtained keyword set and takes the product as the integrated counting value of the category path after the second calculation unit obtains the keyword counting values of the keywords in the keyword set.

In the example of the present disclosure, after obtaining the keyword set of the commodity title input by the user and determining the set of category paths containing the keyword set, the category path recognition system can further calculate the integrated counting value of each category path in the set of category paths to select the category path with the largest integrated counting value as the category path of the commodity title input by the user, so that effective recognition of the category path of the commodity title can be realized without the user's determining the category path for the commodity title level by level, thereby reducing the user's workload and saving the user's time, and further the incorrect category path recognition due to the user's wrong operations can be avoided, thereby effectively improving user experiences and processing efficiency of the user's device.

FIG. 5 shows a structure of the second calculation unit 404 in an example of the present disclosure. As shown in FIG. 5, the second calculation unit 404 includes a second searching unit 501 and a fourth calculation unit 502 (namely a calculation module) which are to calculate the keyword counting value for each keyword in the keyword set under each category path in the set of the category paths.

The second searching unit 501, for each keyword in the keyword set under each category path in the set of the category paths, is to search the keyword and category path count table to determine the first counting value of the number of occurrences of keywords under the category path, search a keyword count table in the commodity category recognition model to determine the second counting value of the total number of occurrences of the keywords, and search a category path count table in the commodity category recognition model to determine the third counting value of the total number of commodity titles under the category path. Herein, the keywords count table contains the counting value of the total number of the occurrences of each keyword, and the category path count table contains the counting value of the total number of the commodity titles under each category path.

The fourth calculation unit 502, for each keyword in the keyword set under each category path in the set of the category paths, is to calculate the keyword counting value of the keyword under the category path by utilizing the first counting value, the second counting value and the third counting value.

In an example, the fourth calculation unit 502 includes a fifth calculation unit 503 (namely a first calculation sub-module) and a sixth calculation unit 504 (namely a second calculation sub-module). The fifth calculation unit 503 is to calculate the product of the second counting value and a predefined first parameter and the product of the third counting value and a predefined second parameter, and to take the sum of the two products as a fourth counting value. The sixth calculation unit 504 is to calculate the quotient of the first counting value divided by the fourth counting value, and to take the quotient as the keyword counting value of the keyword under the category path.

In the example of the present disclosure, the category path recognition system can determine the category path of the commodity title input by the user by utilizing the commodity category recognition model, and can effectively achieve the recognition of the category path of commodity title without the user's determining the category path for the commodity title level by level, thereby reducing the user's workload and saving the user's time, and further the incorrect category path recognition due to the user's wrong operations can be avoided, thereby effectively improving user experiences and processing efficiency of the user's device.

A machine-readable storage medium is also provided, which is to store instructions to cause a machine such as the computing device to execute one or more methods as described herein. Specifically, a system or apparatus having a storage medium that stores machine-readable program codes for implementing functions of any of the above examples and that may make the system or the apparatus (or central processing unit (CPU) or microprocessor unit (MPU)) read and execute the program codes stored in the storage medium.

Therefore, the system shown in FIGS. 3 and 4 may include a memory 31 and a processor 32, the memory 31 stores instructions executable for the processor 32. The memory 31 may include the obtaining unit 301, the processing unit 302 and the determination unit 303, and through executing the instructions read from the obtaining unit 301, the processing unit 302 and the determination unit 303, the processor 32 can accomplish the functions of the obtaining unit 301, the processing unit 302 and the determination unit 303 as mentioned above. Therefore, a system of category path recognition including a memory and a processor is provided, where the memory stores instruction units executable for the processor, and the instruction units include the above units 301˜303.

In this situation, the program codes read from the storage medium may implement any one of the above examples, thus the program codes and the storage medium storing the program codes are part of the technical scheme.

The storage medium for providing the program codes may include floppy disk, hard drive, magneto-optical disk, compact disk (such as CD-ROM, CD-R, CD-RW, DVD-ROM, DVD-RAM, DVD-RW, DVD+RW), magnetic tape drive, Flash card, read-only memory (ROM) and so on. Optionally, the program code may be downloaded from a server computer via a communication network.

It should be noted that, alternatively to the program codes being executed by a computer (namely a computing device), at least part of the operations performed by the program codes may be implemented by an operation system running in a computer following instructions based on the program codes to realize a technical scheme of any of the above examples.

In addition, the program codes implemented from a storage medium are written in storage in an extension board inserted in the computer or in storage in an extension unit connected to the computer. In this example, a CPU in the extension board or the extension unit executes at least part of the operations according to the instructions based on the program codes to realize a technical scheme of any of the above examples.

The above description just shows several examples of the present disclosure in order to present the principle and implementation of the present application, and is in no way intended to limit the scope of the present application. Any modifications, equivalents, improvements and the like made within the spirit and principle of the present application should be encompassed in the scope of the present application.

What is claimed is:

1. A method of category path recognition, comprising:
obtaining from a user device over a network, by a server, a commodity title input by the user through the user device;
performing, by the server, word segmentation on the commodity title to obtain a keyword set comprising keywords comprised in the commodity title; and
determining, by the server, a category path of the commodity title according to the keyword set and a preconfigured commodity category recognition model,
wherein the commodity category recognition model comprises correspondences between a plurality of keywords and a plurality of category paths and a counting value of the number of occurrences of each of the keywords under each corresponding category path.

2. The method of claim 1, wherein a process of determining the category path of the commodity title according to the keyword set and the preconfigured commodity category recognition model comprises:
searching a first table in the commodity category recognition model to obtain a set of category paths comprising the keyword set, wherein the first table comprises the correspondences between the category paths and the keywords as well as the counting value of the number of occurrences of each of the keywords under each corresponding category path;
calculating an integrated counting value for each category path in the set of the category paths respectively; and
selecting the category path with the largest integrated counting value as the category path of the commodity title.

3. The method of claim 2, wherein a process of calculating an integrated counting value for each category path in the set of the category paths respectively comprises performing the following processes on each category path in the set of the category paths:
calculating a keyword counting value of the number of occurrences of each keyword in the keyword set under the category path respectively;
calculating a product of the keyword counting values of the keywords in the keyword set, and taking the product as the integrated counting value of the category path.

4. The method of claim 3, wherein a process of calculating a counting value of the number of occurrences of each keyword in the keyword set under the category path respectively comprises performing the following processes on each keyword in the keyword set:
searching the first table to determine a first counting value of the number of occurrences of the keyword under the category path;
searching a second table in the commodity category recognition model to determine a second counting value of the number of occurrences of the keyword, wherein the second table comprises the counting value of the total number of occurrences of each keyword;
searching a third table in the commodity category recognition model to determine a third counting value of the total number of the commodity titles under the category path, wherein the third table comprises the counting value of the total number of commodity titles under the category path; and
calculating the keyword counting value of the keyword under the category path according to the first counting value, the second counting value and the third counting value.

5. The method of claim 3, wherein a process of calculating the keyword counting value of the keyword under the category path according to the first counting value, the second counting value and the third counting value comprises:
calculating a product of the second counting value and a predefined first parameter and a product of the third counting value and a predefined second parameter, and taking the sum of the two products as a fourth counting value; and
calculating a quotient of the first counting value divided by the fourth counting value, and taking the quotient as the keyword counting value of the keyword under the category path.

6. A system of category path recognition, comprising: a memory and a processor, wherein the memory stores instruction units executable by the processor, and the instruction units comprise an obtaining unit, a processing unit and a determination unit, wherein:
the obtaining unit is configured to obtain from a user device over a network a commodity title input by a user through the user device;
the processing unit is configured to perform word segmentation on the commodity title to obtain a keyword set comprising keywords comprised in the commodity title; and
the determination unit is configured to determine a category path of the commodity title according to the keyword set and a preconfigured commodity category recognition model,
wherein the commodity category recognition model comprises correspondences between a plurality of keywords and a plurality of category paths and a counting value of the number of occurrences of each of the keywords under each corresponding category path.

7. The system of claim 6, wherein the determination unit comprises:
a first searching unit configured to search a first table in the commodity category recognition model to obtain a set of category paths comprising the keyword set, wherein the first table comprises the correspondences between the category paths and the keywords as well as the counting value of the number of occurrences of each of the keywords under each corresponding category path;
a calculation unit configured to calculate an integrated counting value for each category path in the set of the category paths respectively; and
a selection unit configured to select the category path with the largest integrated counting value as the category path of the commodity title.

8. The system of claim 7, wherein the calculation unit comprises a first calculation subunit and a second calculation subunit, wherein:
the first calculation subunit is configured to, for each category path in the set of the category paths, calculate a keyword counting value of the number of occurrences of each keyword in the keyword set under the category path respectively;
the second calculation subunit is to, for each category path in the set of the category paths, calculate a product of the keyword counting values of the keywords in the keyword set under the category path, and take the product as the integrated counting value of the category path.

9. The system of claim 8, wherein the first calculation subunit comprises:
a second searching unit configured to, for each keyword in the keyword set and each category path in the set of the category paths, i) search the first table to determine a first counting value of the number of occurrences of the keyword under the category path, ii) search a second table in the commodity category recognition model to determine a second counting value of the number of occurrences of the keyword, and iii) search a third table in the commodity category recognition model to determine a third counting value of the total number of the commodity titles under the category path, wherein the third table comprises the counting value of the total number of commodity titles under the category path and the second table comprises the counting value of the total number of occurrences of each keyword;
a calculation module configured to, for each keyword in the keyword set and each category path in the set of the category paths, calculate the keyword counting value of the keyword under the category path according to the first counting value, the second counting value and the third counting value.

10. The system of claim 9, wherein the calculation module comprises:
a first calculation sub-module configured to, for each keyword in the keyword set and each category path in the set of the category paths, i) calculate a product of the second counting value and a predefined first parameter and a product of the third counting value and a predefined second parameter, and ii) take the sum of the two products as a fourth counting value; and
a second calculation sub-module configured to, for each keyword in the keyword set and each category path in the set of the category paths, i) calculate a quotient of the first counting value divided by the fourth counting value, and ii) take the quotient as the keyword counting value of the keyword under the category path.

11. A non-transitory machine-readable storage medium, storing instructions configured to cause a machine to execute the method of claim 1.
